(19) United States
(12) Patent Application Publication
(10) Pub. No.: US 2011/0288901 A1
(43) Pub. Date: Nov. 24, 2011

(54) INTERNET-BASED CONSULTATION SERVICE AND ON LINE CONTACT SCHEDULING

(75) Inventor: Melissa L. Mellen, Amherst, NH (US)

(73) Assignee: Wild Angel Cozy Company LLC, Amherst, NH (US)

(21) Appl. No.: 13/110,410

(22) Filed: May 18, 2011

Related U.S. Application Data
(60) Provisional application No. 61/345,706, filed on May 18, 2010.

(51) Int. Cl. G06Q 10/00

(52) U.S. Cl. 705/7.19

(57) ABSTRACT

A service uses internet, intranet or other network based deployment and technologies to encourage and facilitate customers 12 in losing weight or achieving some other desired goal. The weigh-in service uses a novel online scheduler 24 and tracks customer weigh-ins, graphical and pictorial tracking of these weigh-ins, online food and nutritional information, reinforcing emails, and a consultant who “cheerleads” her/his customer to successful weight loss. Customers who seek additional motivation will be able to use a wifi scale at weigh-ins to keep them on track. The overall program is aimed at providing quick bursts of support, referred to as “cheerleading” for a customer on any type of diet, and/or exercise regimen or other goal based program. The consultant will refocus the customer to keep the customer on their program. The online chat scheduler operates in connection with or autonomously from the weigh-in service and allows the consultants and users (or first parties and second parties) to schedule and pre-pay for appropriate times during which online chat will be available to the customer or first party and not available or viewable at any other time.

### CROSS-REFERENCE TO RELATED APPLICATIONS

This application claims priority from U.S. Provisional Patent Application No. 61/345,706, titled “Internet-Based Weigh-In Service” filed May 18, 2010 and incorporated fully herein by reference.

### TECHNICAL FIELD

The present invention relates to a service that is Internet based and more particularly, to an innovative process that uses the Internet to encourage and facilitate customers in achieving their weight loss or other goals through the use of interaction with counselors, and also relates to a specialized online chat scheduling and contact scheduling mechanism.

### BACKGROUND

Excess weight gain and obesity are major problems throughout the United States and other countries. Excess weight gain can lead to a multitude of health problems. Obesity continues to be the leading preventable cause of death that exists in the world. Many people try to lose weight every year and unfortunately, most are not successful. Many of these individuals would do better at achieving their weight loss or other goals if they had positive reinforcement from a “cheerleader” type counselor or mentor who could help monitor their progress and encourage them to continue to reach their goal (whatever that might be).

There are many systems and methods available that allow individuals to communicate with one another utilizing a computer system or other electronic device coupled over the World Wide Web, intranet or other network or by cellular phone service. For example, instant messenger, texting programs, online chat programs, voice over IP (VOIP) are but a few examples of such communication systems and methods. In order for an individual to use such communication mechanisms in the context of a commercial endeavor, the user must typically contact a company, contact Center, website or the like and inquire as to whether or not this type of communication services available to the user at the present time. The availability of the communication service to the user at the present time is dependent upon various circumstances including the availability of a party to speak with the user; whether or not the user is authorized to speak to a requested party at the present time, place or date; as well as other criteria.

Accordingly, what is needed is an easy to use, internet based method and system that can assist a user at any time of the day or night convenient to the user and located anywhere in the world in achieving their weight loss or other goals. Further, such method should include an automated or manual online chat or other computer-based communication control program which may schedule online communication between a user any 3rd party by controlling the user's ability to access the online chat capability based on the user's payment schedule or other predetermined criteria and in combination with such other criteria. Such a program may be separate or part of the online chat program, located on the site or server or at some other location or on some other server.

### SUMMARY OF THE INVENTION

The present invention relates to an innovative process that uses internet technologies to encourage and facilitate customers in losing weight or achieving some other goal. Although the present invention will be explained in the context of weight loss, this is for exemplary purposes only as the method and system disclosed and claimed herein may be used to reach any personal goal or for any other purpose as directed by a 3rd party, for example, as might be requested by a doctor to follow up on some illness or condition that a user is experiencing.

Through the use of specialized online scheduling tools of customer weigh-ins, graphical and pictorial tracking of these weigh-ins, online food and nutritional information, reinforcing emails and personal on-line “cheerleading”, a consultant “cheer leads” her/his customer to successful weight loss or achieving of the goals. Customers who seek and/or desire additional motivation will be able to use a wifi scale (or other wifi or computer connectable device) and which connects and/or transmits information to the service website and into a customer's account utilizing the Internet or other communication mechanisms such as cellular phone service at weigh-ins to keep them on track. The wifi scale or other Wi-Fi device would provide extra incentive for those customers who get off track at weigh-in or other goal issue by not reporting their correct weight thus not getting the positive “cheerlead” they need to get back on track. The overall program is aimed at providing quick bursts of support, referred to as “cheerleading” for a customer on any type of diet and/or exercise regimen. The “consultant” will refocus the customer to keep the customer on their program. In the context of the description of the present invention, it is intended that the so-called “consultant” may take the form of an individual with various roles, credentials and/or education. It is intended that the consultant will not overstep his or her bounds. A consultant may mean a “cheerleader” that is, someone who merely interacts with the user to make them accountable and encourages them to keep striving for their goal even if they have had a bad week, or may range to a licensed professional such as a doctor, nurse, dietitian, or someone in between.

In the preferred embodiment, the invention will be a new approach to assisting people with weight loss and/or other goals. The approach will consist of quick motivational consultations and weigh-ins that will give time conscious motivation to keep people on track to reach their weight loss goals. Previous services have focused on in office visits or long term coaching as part of a motivational process. This service will be different in that there will be no formal training given to consultants and the consultants will serve the purpose of cheerleader by listening and providing positive feedback to those trying to lose weight. This will enable consultants to help anyone on any diet program to accomplish their personal goal.

The consultant will use the website to schedule and participate in online chat, instant message, text or the like with customers at scheduled times, selected by the customer, as set by the consultant (e.g. the consultant enters when they are available to chat and the customer selects a time) and based on the amount of payment entered or provided by the user. The option to select weigh in time maybe goverened by additional criteria, either thru automatic means, such as a selected payment schedule or manual means such as a counselor entering and/or scheduling the user's scheduled chats.

First a customer will select how much time and how many times they want to log in based on a payment schedule. This information will be passed to the scheduler. The customer will then be allowed to select up to the amount of time they have paid for. (conversely this time may be set by the counselor or doctor or whoever is controlling the allowed time rather than using automatic means). Once a customer has chosen a scheduled time, an online chat button in the customer's account will be active at that or those times and only at that or those times. The consultant can then set the window for which the button is active. The button will turn off and become inactive when that window is over. For example, the consultant may determine that they will give the user or customer a 10 min. “window” of time in which to login to the online chat feature. After the expiration of that “window” of time, the online chat button will either not be visible to the user or will become inactive until the users next regularly scheduled online chat time. The online chat scheduling is a new approach to maintaining a scheduled online chat time, and controlling (either automatically or manually) the amount of time that can be scheduled based on set or entered criteria. The chat button will be active for a user selectable window by the consultant, thus enabling the consultant to control work flow as has not been done previously, and thereby allowing the consultant or the web site to manually or automatically control the scheduling based on a payment schedule or other criteria.

The customer will provide their weight or other information, either by chatting it with the consultant or by wifi scale, at the scheduled chat times and receive feedback or cheer from their consultant to help them stay on their diet. The consultant may enter the data for display in the customer's account or the data may be entered automatically using a Wi-Fi scale.

The company will recruit consultants, and provide consultants with a kit to enable them to set up their own eWeighIn business. The consultant will provide this service to individual customers and host companies. The individual customers will have a personal account to access their consultant, on line chat, email scheduling, online chat scheduling and personal data. A host company that is a customer will have a corporate account that will have a transparent interface (e.g. will look like the company's website rather than eWeighIn). The employees of the host company or their customers will have personal accounts thru their personalized interface. The consultant will have an interface to service them in the same way they would service a single client. Customized services may be used in some circumstances.

To help facilitate customers reaching counselors that they feel comfortable with the site will provide a searchable database of counselors. Searches will include consultant information such as how much weight they have lost, how much weight they want to lose, what diets they have done, hobbies, sports, kids, no kids and other personal info, which may include marital status, age, etc that consultants wish to provide.

To help customers with diet issues the website may provide a food database. The database will have food nutritional content and diet specific information. This may include information on which foods are acceptable on specific diets, as well as rough cost equivalent foods and other food comparison information (e.g. frozen vs. fresh), which will be aimed at helping people cut food costs and obtain the most nutritious foods available for their money.

It is important to note that the present invention is not intended to be limited to a system or method which must satisfy one or more of any stated objects or features of the invention. It is also important to note that the present invention is not limited to the preferred, exemplary, or primary embodiment(s) described herein. Modifications and substitutions by one of ordinary skill in the art are considered to be within the scope of the present invention.

### BRIEF DESCRIPTION OF THE DRAWINGS

These and other features and advantages of the present invention will be better understood by reading the following detailed description, taken together with the drawings wherein:

FIG. 1 is schematic diagram of an exemplary system for implementing the present invention.

### DESCRIPTION OF THE INVENTION

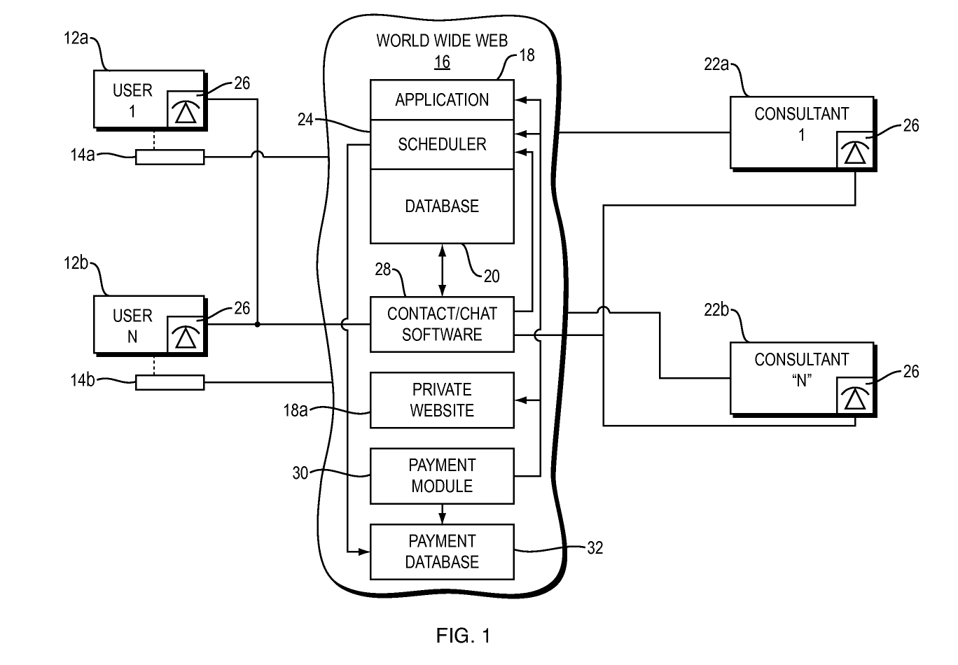

The present invention features a method utilizing, for example, a system 10, FIG. 1, that includes a business model including a service that provides a weigh-in service and/or an on-line communication mechanism (utilizing online and/or other computer/electronic device and based communication mechanisms such as, but not limited to, Instant Messaging (IM); online chat; Skype® communications, a telephone or cell phone or the like).

Although the present invention will be explained in connection with a weigh-in service, this is not a limitation of the present invention as the principles of the invention may be applied to many different services. Moreover, the online chat control feature the present invention may be applied to any online chat or communication for any reason or purpose.

The service encourages and supports an individual or customer by giving them brief or extended positive messages, along with a dose of “peer pressure” to help them realize their weight loss or other goals. The individual can be participating in any number of traditional diet and/or exercise regimens. The weigh-in service is flexible enough to accommodate any type of diet and/or exercise of an individual.

The online communication mechanism feature of the present invention allows a user to communicate with a professional or other connected individual, such as a weight loss counselor or the like, on predetermined days and at predetermined time(s) based on the payments that have been entered by the user or in the case of a nonpaying system, based upon the directions of an individual such as a doctor or the like. The online communication mechanism further features the ability for the user to have a communication session with a counselor or other individual without logging into a web site.

The weigh-in service offers flexibility in the weighing process. The weigh-in service model according to the exemplary embodiment, gives customers or users 12 a choice in how many days per week they would like to weigh-in. A customer can weigh-in everyday or weigh-in once per week or any other variation as determined and paid for by the customer. The customer will then have their weight recorded to an individual account (database) 20 that is part of and maintained by the website or application(s) 18 located on a server somewhere on the World Wide Web, intranet or other network 16, either by computer, smartphone or other communications device, by phone, by a scale 14 connected directly to the World wide Web, intranet or other network 16 (such as a wifi scale) or to the user electronic device 12 (such as by a cable to a USB Port), by online chat or another method.

In one embodiment of the present invention, each customer will be signed up or registered by a “consultant”. The customer or user 12 can select the consultant 22 or the consultant 22 can be assigned to the customer 12. The application 18 will present an opportunity for customers 12 to select the consultant 22 from a searchable database of consultants which is part of the database 20 maintained by the application 18. A customer will be able to search for a consultant 20 that shares their interests such as, for example, diet interests, weight loss issues, sports interests, hobbies and any other information consultants wish to share such as marital status, children, no children etc. with their customers and potential customers. This will help customers locate a consultant 22 that the user feels is “best suited” to “cheerlead” them to a successful weight loss goal, by ensuring that the consultant is someone that the customer can relate to with a common bond or interest. The consultants 22 may also provide additional personal information in the database 2 utilizing a video, power point or any other suitable option or medium. In one embodiment, the consultant will record the customer's weight in the customer database which is also part of the application database 20, and give them a quick cheerlead or words of encouragement, while in another embodiment, the customers weight may be provided directly to the application 18 using the Wi-Fi scale 14.

Each customer 12 will have an individual private user account in the database 20. The service or application 18 will offer customers various services including graphical output of their weigh-in, which will be kept in their private user account. The service may also offer optional advice and consultation from a nutritionist, exercise professional or other relevant “counselor” 22. The service may further offer referrals to other counselors 22 or to health care or other professionals. The service will weigh-in anyone (provided they do not have health issues that preclude them) from any diet program or food regimen.

In addition to the time spent speaking with a consultant 22, the service or application 18 or the consultant 22 will or may offer the customer random or scheduled email reinforcement to the customers for their program. This part of the service would allow customers to have emails that address specific events (i.e. Mom visiting, weekends, vacations etc.) where they expect they may overeat or eat unhealthy, as well as providing emails at specific times of day when a customer may be prone to overeat (i.e. between the hours of 2 and 4 in the afternoon) with a selectable motivational style message.

In this embodiment, consultants 22 will be rewarded or compensated based upon the number of users or consumers 12 that they “signed up” and also based upon the level of service that the user 12 signs up and pays for.

In another embodiment of the present invention, the consultants will be recruited and compensated using reward driven incentives or paid as employees. The business may reward customers and consultants with public acknowledgement in various venues as deemed appropriate.

The business or service model will have focus on both consultants and on customer services. The business will recruit, support and monitor the consultants. The consultants, however, do not need extensive “specialized” training, skills or background since they are not acting as nutritionists or personal trainers but rather, simply as “cheerleaders”. The website will provide a brief video and or power point presentation and other possible media to potential consultants that explain how the company can help a consultant make money.

The company may provide a purchasable kit in order to recruit consultants. The kit, purchased by the consultant, may include software and/or a special link to the web application 18 that will provide an interface for the consultants to access a private (not shared with other consultants or customers) account on the web site 18. Their account will provide a portal to their online chat “office” and their scheduler 24, and other social media services accounts such as twitter™ and/or facebook™ account links on the web site 18, their bio, their auto emailing accounts, their searchable terms, and any other marketing options they choose to set up.

The software may also include an instruction set, which includes video, PowerPoint or other multi-media that explains the company's goals and how it will support/assist the consultant, what the requirements are for the consultant, what the company has rights to, and a complete payment schedule. The software will further include a database that will help the consultant keep track of and recruit local members on their own PC (auto uploadable to both the consultant's account and back-up system). The consultant can utilize a personal computer, or any other device that has an internet connection, such as a personal digital assistant, Blackberry™, or other internet-based device.

Additionally included may be a program that will help the consultant deal with tax information for their consultant business. The software may also include information specializing in specific diets. For example, a consultant may choose to specialize in specific diets, such as Weight Watchers™or South Beach™ in order to provide a specific service of weigh-ins, coaching and diet suggestions for those existing companies and/or specific diets. The software may also include downloadable advertising media such as a brochure, email advertisement, and other forms of advertising and marketing.

The consultant will have the ability to upload a video or use a standard presentation format for their own “sales pitch” for why a potential customer should “weigh-in” or otherwise become associated with them. This will be particularly valuable for on line inquiries. The consultant will be expected to recruit through personal contacts as well as through e-mails, cold calls, or other forms of recruitment. The consultant may even hold home or office “parties” to discuss and promote his or her services as a consultant and therefore to “recruit” users to become associated with them.

The web site or application or applications (there may be more than one) 18 will also provide the consultants with traffic (customers) via the internet. The service will include an online chat interface 28, which will record all chats (accessible to the service owner for quality control purposes) and show all data provided by the chat software (such as geographical location, duration of chat etc.). The data information will be used for cost and effect analysis by both the business and the consultants.

One feature of the present invention is an online scheduler 24 interface that will allow the consultant 22 to set the hours and days they want to make themselves available for on-line chat and/or weigh-ins. By online chat, the present invention contemplates communications sessions between a user 12 and a consultant 22 performed by instant messenger (IM), e-mail, telephone (using a lane line or cell phone) Skype®, texting or the like. The online scheduler 24 allows the consultant 22 to set their own hours and to work as many or as few hours as they determine is appropriate or desirable for their schedule.

In addition to the consultant 22 setting their own schedule to be used by the schedule or 24, present invention features a payment module 30 which allows the user to select a plan and, through the use of any well-known means such as a shopping cart or the like, pay for the plan selected by the user following which the payment information may be inserted into a separate payment database 32 which is accessed by the schedule or 24 to determine when and how many times a user may access a consultant based on the payment entered by the user. In this embodiment, the payments information is automatically accessed by the schedule or 24 to automatically schedule chat sessions between the user 12 and a consultant 22.

As an alternative to the traditional payment plan described above, the present invention also contemplates a situation where a user does not have to pay for service or where service has been prepaid by a 3^{rd} party such as a corporation, Medicare, health insurance company or the like. In this case, a consultant (which may be a doctor, nurse or the like” is provided a portal or interface into the scheduler 24 to schedule chats and other conversations with the user 12. For example, a user 12 who is having heart problems may be provided with a Wi-Fi heart monitor and asked to use it 3 times a day. Information from the heart monitor will be provided directly to the application 18 and entered into the user database 20. In this case, there is no payment required by the user and the nurse acting as the “consultant” can manually enter in the times as directed by, for example, the doctor. In this embodiment, the present invention may also include an alarm or alert which will alert a consultant or other interested party. The data will automatically enter a user's account and may include red “flags” which activate other things—like emails or “alarms”. For instance, if there is if a heart monitor reading scheduled and the data comes in high or wrong, and email, audible alarm or the like may go to a nurse or doctor. Likewise if a weight comes in higher than the day before, an automatically generated email may be sent to a counselor suggesting that they touch base with the person or an email should be sent to them saying “Hey let's get back on the program” or the like.

When a customer 12 selects a time, the scheduler 24 will automatically set the online chat button 26 on the users system 12 to be available and/or visible only to that customer for a predetermined length of time, set by the consultant, around the scheduled weigh-in or chat time. The scheduler 24 will have access to information in the database 20 about the customer including chat times, dates, and time frames the consultant 22 wishes to provide chat opportunity to the customer 22, as well as e-mail address, IP address, Skype address and any other relevant information required by either the application or website 18 or the contact/chat software 28 (as will be explained in greater detail below) to establish and display a chat opportunity to a user 12 at the appropriate time and for an appropriate time frame. Chat capabilities at all other times will be blocked and/or not displayed.

For example, if the customer selects to “chat” with the consultant every Tuesday at 4:00 PM, the application 18 under control of the scheduler 24, will cause to be displayed on the display device of the user 12 a “chat” icon 26 only at the appropriate time. Thus, beginning at 4:00 PM, the chat icon 26 will be displayed on the user's display device. The duration or length of time in which the chat icon 26 will be displayed will be determined and set by the counselor 22. Alternatively, the chat icon may be displayed but inactive at all times when it is not active.

For example, the counselor may program the scheduler 24 to allow a five-minute or even 10 minute “window” of time in which the chat icon 26 will be available and/or visible to or selectable by the user 12. After this time, the chat icon that will no longer be visible or selectable and the user or customer 12 will have to wait until his or her next regularly scheduled time to engage in that with the counselor 22. This scheduling method enables the consultant 22 to insure that online chats with customers 12 flow and adhere to a schedule. The scheduling method will also insure that customers can only online chat when they are scheduled. If customers are not scheduled, the customer's online chat button will be inactive and/or preferably not visible. This method is thus automatic and does not require the use of a call center or contact center “operator” to handle an inquiry from a customer only to determine that the customer has not paid for the appropriate consultation or that the consultant is not available

In a first embodiment, the online chat feature of the present invention may require that the user 12 to “login” to the application or website 18 in order to participate in and/or be made aware of the online chat feature and capabilities of the present invention. In this embodiment, the “chat” feature will be run by and through the application 18.

In another embodiment, it is contemplated that the server and/or application 18 may further include a separate contact/chat software module 28 which provides for the requisite online chat features of the present invention and which configures and provides the chat capabilities of the present invention without a user having to be logged into the application 18. The contact/chat software 28, which is within the skill of those of ordinary skill in the art, is preferably coupled to the database 20 and/or scheduler 24 (as well as the payment module 30 and/or payment database 32) so as to have access to the scheduler 24 to appropriately schedule the times and dates that a user 12 will be allowed to chat with a consultant 22.

The assistive software provided to the consultants may also include instructions for setting up a twitter™, facebook™ or other social media account. Through these various social media, the consultant will be required and/or encouraged to engage in positive messaging with their customers. Preferably, the consultant should make contact with their customers on a daily or weekly basis. The consultants will be provided with access to select and schedule positive emails for their customers, and will be encouraged with rewards and/or acknowledgements, to add new emails to the database on the main site, as well as pre-included positive emails. The software may also include other options and services to the consultants.

Preferably, the software should focus on setting up a complete business for the consultant. The software will come with support that will be made available via online chat which can be scheduled thru an online scheduling system, by phone, in person, in group meetings or any other communication venue, all of which may employ the use of the online scheduling program.

The business will also focus on obtaining and serving customers thru online communication and other available options. The web site 18 will be the major marketing tool, explaining the features that the weigh-in service has and how it may benefit the customer. The web site 18 will permit the consultants 22 to provide a weigh-in service thru a customer's 12 personal account. The customer 12 will be able to search an online consultant database 20 to locate the best consultant 22 to meet their needs. The database 20 will be searchable by the consultant's (diet) experience (e.g. have the done the south beach™ diet or Atkins™ etc.) how much weight they have lost, how much weight they are trying to loose, sports they like, hobbies they have, marital status, children or no children etc. In this way, the customer can find a consultant who they feel they can best relate to who has or has had similar experiences, goals and lifestyles.

Customer accounts will provide access to their consultant's schedule in conjunction with the payment module and payment database 30/32. Customers will be able to access the weigh-in service from any device 12 that has access to the internet 16. Customers will be able to schedule weigh-ins at a specific time or at specific time intervals. For example, a customer can schedule a weigh-in from 10:00 AM-10:15 AM. The customer will log into their account and find an active chat icon at their scheduled weigh-in time. When the chat icon is active, the customer can chat with their consultant regarding their weight and/or any other weight related issues they are having. The customer will preferably have a short chat time with the consultant. The online chat button will be inactive at other times when the customer does not have a scheduled weigh-in. If the customer fails to show up at the scheduled time an automatic email or consultant's email may be triggered and sent at varying intervals to encourage communication from the customer 12.

The website 18 may also offer information that will include multiple references that will assist the customer 12 in their (weight loss) goals. These databases may include food types, nutritional data, and a variety of applicable diets. The database may include information about the different diet types, the types of foods that should be eaten or should be avoided and other reference materials. The information on the website may also offer rough food cost equivalents or recommendations for nutritional value (i.e. fresh vs. canned vs. frozen). For example, the information may offer comparison data about different types of food, their nutritional values and their costs, which can be easily compared by the customer. The website may also include recipes that can be used for different types of food and different diets, each with calorie count. The customer will be able to assemble full menus from the website database for their chosen daily caloric intake.

Additionally, the customer 12 may be able to “online schedule” a consultation with a different “consultant” 22 such as a nutritional consultant, exercise professional, healthcare provider or other third party 22 as an “extra cost” option. The ability to online schedule such a consultation will also be coupled to and driven by the payment module 30 in the users payment database entries 32. Thus, as long as the user pays for this feature he or she will be able to schedule it.

These consultations can be done online, by phone or in person. The customer will have an account that contains all of the customer's data including the online charting of the customers weigh-in progress. The customer will have access to an email section of the scheduler 24, which they can set to automatically email them when they need extra incentive or they can request the consultant select and schedule the email. The customer 12 may also have a link to their consultant's twitter™ and facebook™ account as well as a link to the weigh-in site 18. The customer will be able to receive direct marketing and other functions from the consultant's personal account as well as the weigh-in site. The customer will have a suggestion box in their account where they are free to suggest any new thoughts for the business or the consultant.

In another embodiment of the present invention, a direct customized weigh-in web site service can be offered to a host company. Some examples of host companies that may employ this weight loss program include gyms, Doctor's offices, weight loss centers, insurance companies and other private companies. The host company would customize a log in and subsidiary web site 18a that would permit companies to offer the weigh-in service to their employees or customers using the host company's branded image or logo on the subsidiary site 18a. The subsidiary site would appear to be operated as the host company's web site such that a user of the service associates the service with the host company. This direct customized weigh-in web site service would provide a seamless look to the host company, wherein the interface would look exactly like a website from the host company. This service would be offered to a host company as a benefit that can be offered to employees. An employee using the weigh-in service would be under the impression that the weigh-in service was entirely affiliated with the host company. The service at one host company would preferably (but not necessarily) be associated with one consultant, who would provide services as previously disclosed to any employees at the host company who participated in the service.

It is important to note that the present invention is not intended to be limited to a system or method which must satisfy one or more of any stated or implied objects or features of the invention. It is also important to note that the present invention is not limited to the preferred, exemplary, or primary embodiment(s) described herein.

Modifications and substitutions by one ordinary skill in the art are considered to be within the scope of the present invention which is not to be limited except by the allowed claims and their legal equivalents.

What is claimed is:

1. A system for connecting a user with a consultant, comprising:
at least one user, said at least one user having access to a device for accessing the World Wide Web, intranet or other network and for communicating with a consultant on a topic of interest to said at least one user;
at least one consultant, said at least one consultant having access to a device for accessing the World Wide Web, intranet or other network and for communicating with at least one user on a topic of interest to said at least one user; and
at least one application program, configured for being accessed over the World Wide Web, intranet or other network by said at least one user and said at least one consultant, said at least one application program coupled to a contact scheduler and at least one database, said contact scheduler responsive to said at least one data base and to a source of user entered criteria, and configured for controlling at least one of how, when, how much and how often said at least one user may consult with said at least one consultant, said at least one database configured for receiving and storing information about one or more users, said information about said one or more users including at least a level of consultancy selected by each said one or more users, wherein said at least one database may be further configured for receiving and storing information about said one or more consultants, said information about said one or more consultants including at least a level of consultancy available to be provided by each said one or more consultants.

2. The system of claim 1, wherein said contact scheduler is responsive to a source of user entered payments and wherein said at least a level of consultancy selected by each said one or more users includes a level of consultancy paid for by each said one or more users.

3. The system of claim 1, wherein said level of consultancy service selected by a given user or set by a given consultant includes the amount of time in a given period that said user desires to have access to a consultant or that the consultant schedules for said user.

4. The system of claim 1, wherein said level of consultancy service selected by a given user includes the time of a given day a user desires to have access to a consultant or the consultant selects for the user.

5. The system of claim 1, wherein said level of consultancy service available to be provided by a given consultant includes the days of the week and time of the day a given consultant is available for consulting.

6. The system of claim 1, wherein said level of consultancy service available to be provided by a given consultant includes one or more interests of said given consultant.

7. The system of claim 6, wherein said application program is responsive to a user request for a consultant with a given interest, for searching said interests of said consultants stored in said database, and responsive to said search, for providing said at least one user with a list of one or more consultants having said given interest from which to choose a consultant.

8. The system of claim 7, wherein said interests of said given consultant are selected from the group consisting of: day of the week available to consult, time of the day available to consult, marital status, family status, subject matter interest, subject matter experience, educational qualifications, preferences, personality type, instructional type, medical issues wherein a doctor is involved, consulting provided as to diet, consulting provided as to weight loss, consulting provided as to nutrition, consulting as provided to exercise, consulting as provided to medical issues where in a doctor is involved.

9. The system of claim 1, wherein said at least one user device having access to the World Wide Web, intranet or other network and said device for communicating with a consultant is one in the same device.

10. The system of claim 1, wherein said at least one user device having access to the World Wide Web, intranet or other network and said device for communicating with a consultant includes two separate devices.

11. The system of claim 10, wherein said device for communicating with a consultant includes a telephone device.

12. The system of claim 9, wherein said at least one user device having access to the World Wide Web, intranet or other network and said device for communicating with a consultant is selected from the group of devices consisting of: a computer, a Smart phone, a touch pad, a wifi enabled device.

13. The system of claim 1, wherein at least one of said user device having access to the World Wide Web, intranet or other network and said device for communicating with a consultant includes a mechanism for entering user specific information available to said consultant.

14. The system of claim 13, wherein said user specific information includes user weight.

15. The system of claim 14, wherein said user weight is stored in said data base.

16. The system of claim 14, wherein said user weight is provided manually by said user.

17. The system of claim 14, wherein said user weight is provided automatically by a scale coupled to one of either said user device having access to the World Wide Web, intranet or other network or directly to the World Wide Web by a World Wide Web enabled scale.

18. The system of claim 1, wherein said scheduler is responsive to said data base for providing a visual indication to said at least one user on said at least one user device having access to the World Wide Web, intranet or other network, of a present availability of a given consultant with whom the at least one user may presently consult.

19. The system of claim 18, wherein said scheduler provides said visual indication to said at least one user for a limited period of time based upon a period of time said user has preselected and preauthorized for to contact a consultant, and wherein at all other times, said scheduler does not provide an active said visual indication to said at least one user.

20. A system for providing an indication to a user at a predetermined time, comprising:
at least one user, said at least one user having access to a device for accessing the World Wide Web, intranet or other network and for communicating with a consultant on a topic of interest to said at least one user;
at least one consultant, said at least one consultant having access to a device for accessing the World Wide Web, intranet or other network and for communicating with at least one user on a topic of interest to said at least one user; and
at least one application program, configured for being accessed over the World Wide Web, intranet or other network by said at least one user and said at least one consultant, said application program including a contact scheduler, coupled to a database, said contact scheduler responsive to said database and configured for controlling at least when said at least one user may consult with said at least one consultant, said data base configured for receiving and storing information about one or more users, said scheduler further responsive to said database for providing a visual indication to said at least one user on said at least one user device having access to the World Wide Web, intranet or other network, of a present availability of a given consultant with whom the at least one user may presently consult, wherein said scheduler provides said visual indication
to said at least one user for a limited period of time based upon a period of time said user has preselected to contact a consultant, and wherein at all other times, said scheduler does not provide said visual indication to said at least one user.

21. The system of claim 20, wherein said scheduler provides a visual indication to said at least one user on said at least one user device having access to the World Wide Web, intranet or other network of a present availability of a given consultant with whom the at least one user may presently consult by means of said at least one application program.

22. The system of claim 20, wherein said scheduler provides a visual indication to said at least one user on said at least one user device having access to the World Wide Web, intranet or other network of a present availability of a given consultant with whom the at least one user may presently consult by means of a contact/chat scheduling module.

23. A system for providing an indication to a user at a predetermined time, comprising:
at least one user, said at least one user having access to a device for accessing the World Wide Web, intranet or other network and for communicating with a consultant on a topic of interest to said at least one user;
at least one consultant, said at least one consultant having access to a device for accessing the World Wide Web, intranet or other network and for communicating with at least one user on a topic of interest to said at least one user; and
a contact scheduler, coupled to a database, said contact scheduler responsive to said database and configured for controlling at least when said at least one user may consult with said at least one consultant, said data base configured for receiving and storing information about one or more users, said scheduler further responsive to said database for providing a visual indication to said at least one user on said at least one user device having access to the World Wide Web, of a present availability of a given consultant with whom the at least one user may presently consult, wherein said scheduler provides said visual indication to said at least one user for a limited period of time based upon a period of time said user has preselected to contact a consultant, and wherein at all other times, said scheduler does not provide said visual indication to said at least one user.

24. A contact scheduler for providing an indication a predetermined time of the ability of at least a first person to contact at least a second, the contact scheduler comprising:
a contact scheduler, coupled to a database, said contact scheduler responsive to said database and configured for automatically controlling when at least a first person may make contact with at least one second person, said data base configured for receiving and storing information about said at least a first person and said at least a second person, said scheduler further responsive to said database, for providing a visual indication to said at least a first person on at least one user device having access to the World Wide Web, intranet or other network of a present availability of said at least one second person with whom the at least one first person may presently may make contact with, wherein said scheduler provides said visual indication to said at least first person for a limited period of time based upon a period of time said first person has previously preselected to contact said at least one second person, and wherein at all other times, said scheduler does not provide said visual indication to said at least a first person.
